(19) United States
(12) Patent Application Publication
(10) Pub. No.: US 2019/0117482 A1
(43) Pub. Date: Apr. 25, 2019

(54) MEDICAL BED

(71) Applicant: DUPONT MEDICAL, Frouard (FR)

(72) Inventor: William BIHR, Avrainville (FR)

(21) Appl. No.: 16/090,374

(22) PCT Filed: Mar. 29, 2017
(86) PCT No.: PCT/FR2017/050721

§ 371 Date: Oct. 1, 2018

(30) Foreign Application Priority Data
Apr. 1, 2016 (FR) 1652860

(51) Int. Cl. A61G 7/012; A61G 7/018; A61G 7/05; A61G 7/10

(52) U.S. Cl. CPC A61G 7/012; A61G 7/1074; A61G 7/0506; A61G 7/018

(57) ABSTRACT

The medical bed has a frame formed at least from two parallel side members secured to a chassis. The chassis has two symmetrical assemblies, each having at least one first arm. A first end of which is mounted so as to rotate with respect to the frame on a first axis parallel to the plane formed by the frame and perpendicular to the side members. Each assembly has at least one second arm; a first end is mounted so as to rotate with respect to the frame on a third axis parallel to the first axis while a second end is mounted so as to rotate with respect to the first arm on a fourth axis parallel to the first axis. There is a mechanism for moving each assembly in translation with respect to the frame between at least one retracted position and a deployed position of the rolling base.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The invention relates to a medical bed of the type comprising a frame made up at least of two parallel beams secured to a chassis equipped with means for adjusting the height of said frame, said chassis comprising two assemblies extending symmetrically below said frame, each assembly comprising at least one first arm, a first end of which is mounted rotating relative to the frame on a first axis parallel to the plane formed by the frame and perpendicular to the beams, said first axis being mounted translatably on the frame along a beam, while a second end is mounted rotatably on a rolling base around a second axis parallel to the first axis, each assembly further comprising at least one second arm, a first end of which is mounted rotating relative to the frame on a third axis parallel to the first axis while a second end is mounted rotating relative to the first arm on a fourth axis parallel to the first axis.

### 2. Description of Related Art Including Information Disclosed Under 37 CFR 1.97 and 37 CFR 1.98

Medical beds are in particular used in hospital centers and traditionally comprise structural means allowing them to be configured based on specific needs of a patient or medical staff. They also aim to meet the needs of patients, elderly individuals who have lost autonomy or suffer from a handicap and/or whose health condition requires long, bedridden periods at home or in specialized care centers. Such beds are in principle designed to facilitate the tasks of caregivers by decreasing the physical efforts they must exert when raising and lowering the patient. Preferably, they must also make it possible to reduce the risks of incorrect manipulations and falls.

Thus, a medical bed generally includes means making it possible to vary the height when lying down, raising or lowering at least part of a portion of the base, and if applicable, movement means such as associated or integrated carriages, making it possible to move them between different periodic usage zones.

This type of bed is either purchased or rented and must be able to be assembled, disassembled, moved and stored easily.

Due to the different functionalities associated with medical beds, they may be very cumbersome and very heavy, and therefore difficult to move. Their assembly and disassembly may prove complex, require special tools and take considerable time, or even require the participation of several operators. Furthermore, they may take up considerable space to store.

To resolve this issue, collapsible medical beds have been developed and are commercially available. In particular known from publication EP 2,583,653 is a medical bed whose removable transport carriage is partially retractable.

Another medical bed, known from document FR 2,769,832, comprises means making it possible to move the two subassemblies forming its rolling base between a usage position and a transport position of the bed, in which they are respectively moved away from and closer to the bed frame.

Despite all of this, the parts making up these two types of beds remain heavy and cumbersome, complex to assemble and disassemble.

### BRIEF SUMMARY OF THE INVENTION

The present invention therefore aims to propose new means in order to resolve the drawbacks of the prior art. In particular, one aim of the invention is to provide a medical bed that is quick and easy to disassemble and reassemble without tools, in order to optimize the tasks of the installer and improve his working conditions. Furthermore, another aim of the invention is also to propose a medical bed that can be transported based on the considered situation, either in the form of a compact assembly with an integrated transport carriage, or in several separate parts handled individually. Indeed, the first solution makes it possible to release the installer from a risk of forgetting or losing elements specific to the transport means of the bed, while the second solution makes it possible to move the bed, if applicable by just one person, in cramped environments. The invention further aims to provide a medical bed having a particularly compact structure in the storage position so as to minimize its bulk when it is stored. In other words, the present invention aims to provide the technical means making it possible to convert, with minimal structural means, in the smallest possible number of operations, safely and reliably, an assembled medical bed into a compact, mobile, self-supporting, transportable and storable assembly, and vice versa.

To that end, the invention relates to a medical bed of the type indicated in the preamble, characterized in that it comprises means for translating each assembly of the chassis relative to said frame between at least a retracted position and a deployed position of said rolling base.

Other features and advantages of the present invention will appear upon reading the following detailed description related to one example embodiment provided for information and non-limitingly.

### BRIEF DESCRIPTION OF THE SEVERAL VIEWS OF THE DRAWINGS

The understanding of this description will be made easier in reference to the attached drawings.

FIG. 1 shows a perspective view of a medical bed according to the invention in the raised reclining position, ready to use.

FIGS. 2 to 7 show schematic side views of the bed of FIG. 1 during various steps of its conversion for transport and/or storage.

### DETAILED DESCRIPTION OF THE INVENTION

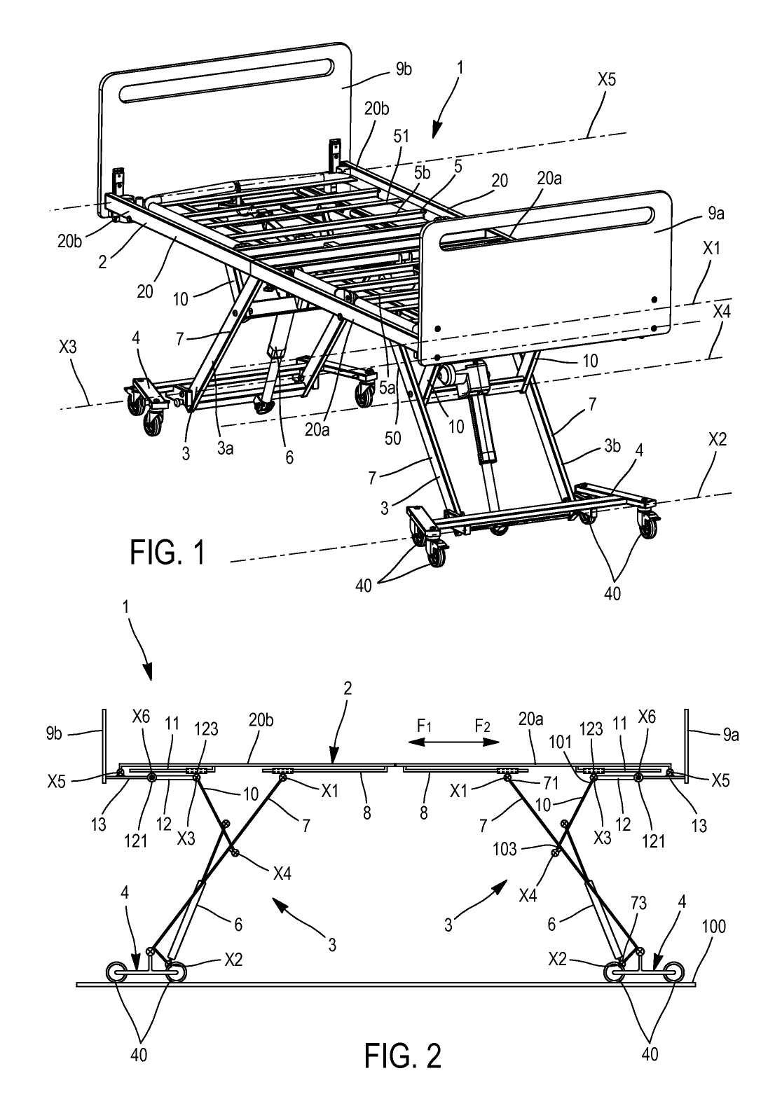

In the example embodiment illustrated in FIGS. 1 to 7, the medical bed 1 according to the invention traditionally comprises a frame 2 secured to a chassis 3, which rests on the floor 100 via two rolling bases 4, each equipped with casters 40. Traditionally, the rolling bases 4 are used to move the medical bed 1 on a flat surface, over a short distance, for example to bring a bedridden patient from one location of the hospital center to another. The frame 2 is made up of two beams 20 each formed by two segments 20a, 20b nested in one another. Thus, the frame 2 in fact comprises two half-frames 2a, 2b each formed by a pair of beam segments 20a or 20b. The frame 2 is intended to receive a base 5 made in two parts 5a, 5b each extending over one of the half-frames 2a or 2b. The base 5 allows the installation of a medical mattress (not illustrated) guaranteeing hygiene and comfort for the user. One of the two parts 5a of the base 5 comprises a headrest 50, while the other part 5b comprises a footrest 51, the incline of which is adjustable. The medical bed 1 according to the invention is further completed by a collapsible headboard 9a and footboard 9b, each defined by a panel, made from a material appropriate for a medical environment, secured to one end of the medical bed 1.

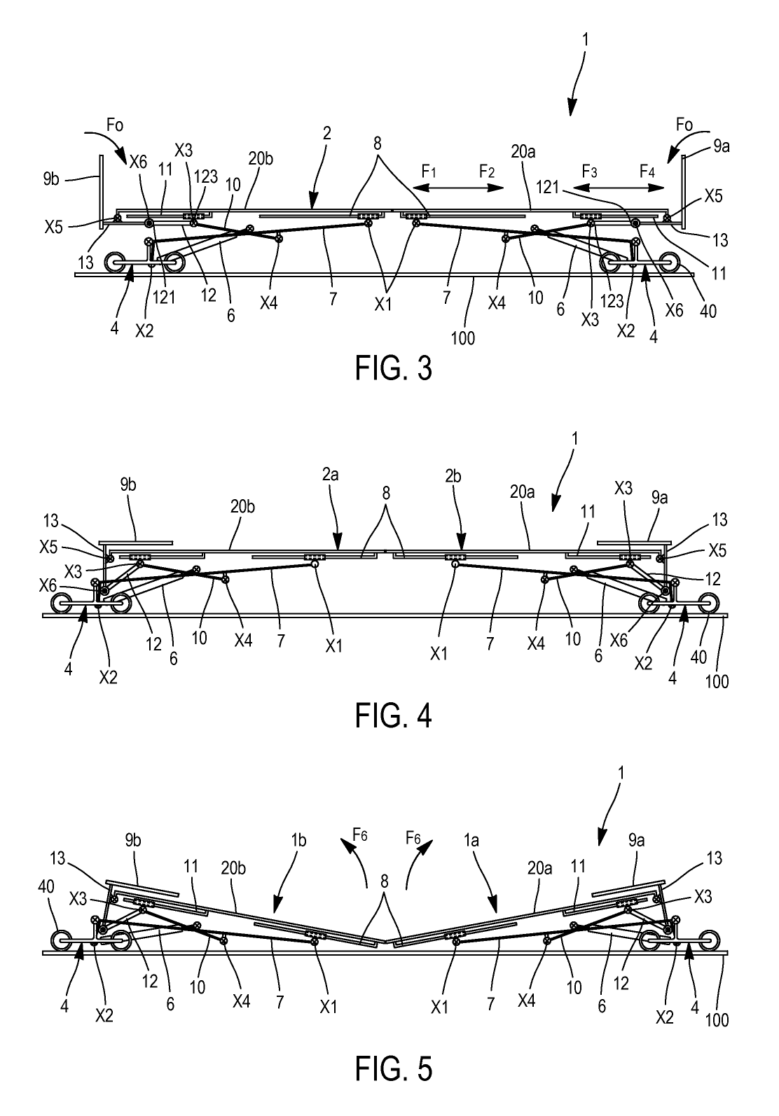

The chassis 3 is suitable for adopting a low position (cf. FIG. 3), in which it is folded against the bed frame 2, and a high usage position (cf. FIG. 1), in which the base 5 extends at a certain height above the floor 100. Thus, the chassis 3 also traditionally comprises a system for adjusting the height of the medical bed 1 actuated by jacks 6.

According to the invention, the chassis 3 is further mounted translatably on the bed frame 2 and can thus be moved, once placed in its low position, between a retracted position (cf. FIGS. 1 to 3), in which it extends in its entirety below the bed frame 2, and a deployed transport position (cf. FIGS. 4 and 5), in which the rolling bases 4 protrude from the bulk of the medical bed 1. The fact that the rolling bases 4 do not protrude longitudinally from the bulk of the medical bed 1 in the retracted position of the chassis 3 makes it possible both to limit said bulk and to prevent the patient and/or people having access to the bed 1 from tripping over the rolling bases 4. Furthermore, in the transport position of the medical bed 1, the fact that the rolling bases 4 protrude from the bulk of the latter makes it possible to convert it into a transport carriage, as will be described in detail hereinafter.

In the illustrated alternative embodiment, the chassis 3 traditionally comprises two assemblies 3a, 3b each equipped with a rolling base 4 and connected to the bed frame 2, symmetrically relative to a plane parallel to the panels forming the headboard and footboard 9a, 9b and extending between the two parts 5a, 5b of the base 5.

Thus, as appears in the figures, the medical bed 1 according to the invention includes first and second modules 1a, 1b connected to one another by securing means (not illustrated) and able to be separated from one another after unlocking of said means. Thus, the first module 1a includes the part 5a of the base 5, the two beam segments 20a of the half-frame 2a, the headboard 9a, the assembly 3a of the chassis 3 equipped with a rolling base 4. The second module 1b includes the part 5b of the base 5, the half-frame 2b, the footboard 9b, and the assembly 3b of the chassis 3 equipped with a rolling base 4.

The two assemblies 3a, 3b of the chassis 3 are identical. They each traditionally comprise two parallel first arms 7, a first end 71 of which is pivotably connected to the bed frame 2, around a first axis X1, parallel to the plane of the frame 2 and perpendicular to the beams 20 of the frame 2. The axis X1 is mounted sliding inside a first rail 8, secured to a beam segment 20a, 20b of the frame 2. It is therefore translatable along said beam segment 20a, 20b along a certain travel in a direction F1 or in an opposite direction F2 (cf. FIG. 2). The second opposite end 73 of each arm 7 is in turn mounted rotating on a rolling base 4 around a second axis X2 parallel to the first axis X1. Each assembly 3a, 3b further comprises two second parallel arms 10, a first end 101 of which is mounted rotating around a third axis X3, parallel to the first axis X1, on a half-frame 2a, 2b, while a second end 103 is mounted rotating around a fourth axis X4 on a first arm 7. Owing to such a structure, each assembly 3a, 3b can occupy the upper usage position of the medical bed 1 illustrated in FIGS. 1 and 2 and the low position illustrated in FIG. 3. Each assembly 3a, 3b is brought toward one of these positions using jacks 6 acting on the first 7 and second 10 arms and that also allow an adjustment of the height of the frame 2 of the medical bed 1 relative to the floor 100.

Owing to the invention, the medical bed 1 further comprises means for translating each assembly 3a, 3b of the chassis 3 respectively relative to a half-frame 2a, 2b making it possible to keep the rolling bases 4 in a retracted position, in which they are kept below the frame 2 (FIGS. 1, 2, 3), or to bring the rolling bases 4 toward a deployed position in which they protrude from the bulk of the medical bed 1 (FIGS. 4, 5).

To that end, the third axis X3, on which a first end 101 of each second arm 10 of each assembly 3a, 3b is mounted rotating, is mounted translatably relative to said frame 2 along a beam segment 20a or 20b. Thus, the invention provides that each third axis X3 associated with an assembly 3a, 3b is mounted sliding in a second rail 11 secured to a beam segment 20a, 20b. The second rail 11 allows the translation, over a certain travel of the second arm 10, in a direction F3 or in an opposite direction F4 (cf. FIG. 3).

Advantageously, the medical bed 1 also includes control means that control the passage of the chassis 3 from the retracted position of the rolling bases 4 to their deployed position and vice versa. These control means allow the movement of the chassis 3 simply and easily by a user working alone and without using specific tools.

Indeed, in reference to the figures, in the illustrated alternative embodiment, each axis X3 is coupled, using a connecting rod 12 and a connecting member 13, to one of the panels defining a headboard 9a or a footboard 9b. Each of said panels 9a, 9b is mounted pivoting using two connecting members 13 relative to a half-frame 2a, 2b around a fifth axis X5, parallel to the first axis X1 between the usage position of the medical bed 1 in which the panel 9a, 9b is perpendicular to the plane defined by the frame 2 (FIGS. 1-3) and a storage position in which it is folded down against the frame 2 (FIGS. 4-7). Each connecting member 13, connected to a headboard 9a or footboard 9b, is also mounted rotating around a sixth axis X6, parallel to the first axis X1, on an end 122 of the connecting rod 12 whereof another end 121 is mounted rotating on the third axis X3.

Furthermore, each connecting member 13 further includes an indexing system making it possible to obtain locking in position of the chassis 3 in the retracted or transport position of the rolling bases 4 and thus to provide the safety either of the patient and medical staff, or of the transporter.

Indeed, owing to the structure described above, when it is provided to transport the medical bed 1 according to the invention to a different location, in particular for storage thereof for reuse, it is very easy for an operator working alone and without specific tools to carry out the various conversion steps of the bed 1 making it possible to take it from its usage state illustrated in FIGS. 1 and 2, to a transport and storage state like that illustrated in FIG. 7.

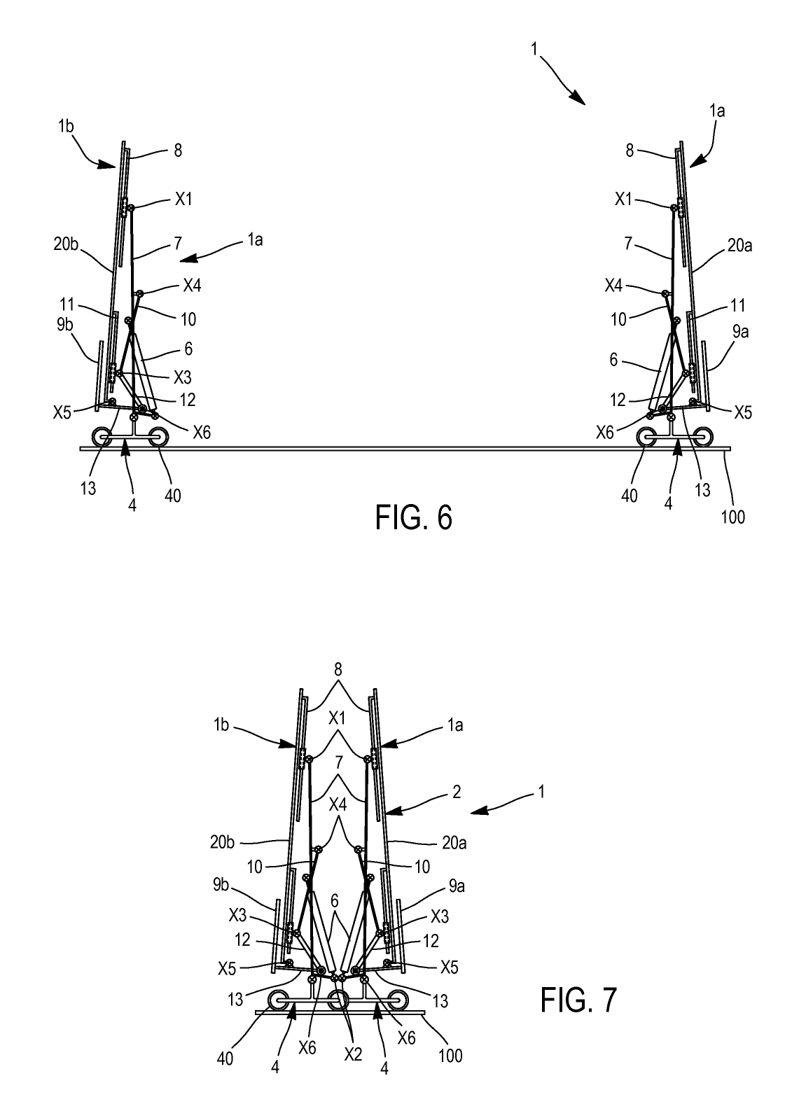

Thus, in reference to FIGS. 1 to 7, a first phase of the conversion of the medical bed 1 according to the invention, making it possible to take it from its usage state (cf. FIGS. 1 and 2) to its transport and storage state (FIG. 7), consists of bringing the chassis 3 back against the bed frame 2, lowering the frame 2 toward its lowest possible position (cf. FIG. 3), corresponding to the aforementioned storage position, in which the entire chassis 3 is also located in the bulk of the medical bed 1 (retracted position of the rolling bases 4). This is done using the means for adjusting the height of the traditional type comprised by the chassis 3, implementing the jacks 6. The operator next folds down the headboard 9a and the footboard 9b toward the base 5 (arrow F0) by pivoting each of them around the fifth rotation axis X5 (cf. FIGS. 3-4), after having unlocked the indexing system of the panels 9a, 9b in the raised position. The headboard 9a and the footboard 9b each being connected to two connecting members 13, the pivoting of the latter around the axis X5 drives that of each connecting rod 12 around the sixth axis X6. The movement of each connecting rod 12 thus obtained is transmitted to the axis X3, which then slides in a rail 11 in the direction illustrated by the arrow F4. This translational movement of the axis X3 relative to a beam segment 20a, 20b is also transmitted to the first axis X1, which moves in the rail 8 in the direction indicated by the arrow F2. One thus obtains a movement of each assembly 3a, 3b of the chassis 3 toward a deployed position in which the two rolling bases 4 protrude from the bulk of the medical bed 1 (cf. FIG. 4). Then, the operator separates the two modules 1a, 1b making up the medical bed 1, after having unlocked the securing means that joined them (cf. FIG. 5). He next pivots the first arms 7 of each subassembly 3a, 3b of the chassis 3 around the second rotation axes X2 (arrows F6) to place each bed half-frame, respectively made up of two segments 20a and two segments 20b of the beam 20, in the substantially vertical position above a rolling base 4 (cf. FIG. 6). The two modules 1a, 1b thus positioned can next be transported and/or stored as is, independently of one another or joined to obtain a compact and transportable assembly as illustrated in FIG. 7. In both cases, the medical bed 1 is taken from a usage position, in which it plays its role as a bed intended to receive a patient, toward a position in which it serves as a transport carriage making it possible to move it using casters 40 of the rolling bases 4. The latter thus advantageously serves both as means for moving the medical bed 1 over short distances and flat surfaces, and means for transporting the bed during a potential move involving manipulating it in corridors, passageways, elevators, etc.

In specific cases where the movement and/or storage of the bed on the transport carriage is unsuitable (stairs, significant level differences, tight passages, unsuitable passenger vehicle trunks, etc.), the present invention also sets out that each module 1a, 1b can be transported as separate parts, each assembly 3a, 3b being able to be separated, easily and without using tools, from the corresponding bed half-frame 2a, 2b, and from the respective headboard or footboard 9a, 9b. Thus, the medical bed 1 may also, if applicable, be moved and/or stored in the form of separate subassemblies (not shown) with weights and volumes acceptable for being carried and manipulated by a single person.

Of course, the reverse operations of those described above also make it possible to reposition the medical bed 1 according to the invention in its usage position illustrated in FIG. 1.

As clearly shown by the preceding, the medical bed 1 according to the invention meets the aims set out in the introduction. It is particularly suitable for rental, which involves frequent assembly/disassembly operations, and preferably assumes easy transport and storage. These operations are greatly facilitated owing to the structure of the medical bed 1 described above, which further makes it possible to achieve substantial savings on labor and storage space.

1. A medical bed, comprising
a frame being comprised of at least of two parallel beams secured to a chassis equipped with means for adjusting the height of said frame, said chassis comprising two assemblies extending symmetrically below said frame, each assembly comprising at least one first arm, a first end of which is mounted rotating relative to the frame on a first axis parallel to the plane formed by the frame and perpendicular to the beams, said first axis being mounted translatably on the frame along a beam, while a second end is mounted rotatably on a rolling base around a second axis parallel to the first axis, each assembly further comprising at least one second arm, a first end of which is mounted rotating relative to the frame on a third axis parallel to the first axis while a second end is mounted rotating relative to the first arm on a fourth axis parallel to the first axis,
said medical bed further comprising means for translating each assembly of the chassis relative to said frame between at least a retracted position and a deployed position of said rolling base.

2. The medical bed, according to claim 1, wherein the third axis, on which a first end of the second arm of each assembly is mounted, is mounted translatably relative to said frame along a beam.

3. The medical bed, according to claim 2, further comprising: a rail secured to a beam, inside which said third axis is mounted sliding.

4. The medical bed, according to claim 2, further comprising: means for controlling the translational movement of the third axis along said beam.

5. The medical bed, according to claim 4, wherein the control means comprise a panel, defining a headboard or a footboard, secured to the third axis and mounted pivoting relative to the frame around a fifth axis, parallel to the first axis between the usage position in which said panel is perpendicular to the plane defined by the frame and a storage position in which said panel is folded down against the frame.

6. The medical bed, according to claim 5, wherein said panel is connected to the third axis using a connecting member mounted in rotation on the one hand on the fifth axis and around a sixth axis, parallel to the first axis on one end of a connecting rod whereof another end is mounted rotating on said third axis.

7. The medical bed, according to any claim 3, wherein the control means comprise means for locking the chassis in the retracted or deployed position of the rolling base.

8. The medical bed, according to claim 1, wherein the frame comprises two half-frames each formed at least by two beam segments connected to one another by reversible assembly means.

9. The medical bed, according to claim 8, further comprising: two modules, each module being formed at least by a half-frame connected by reversible assembly means to an assembly of the chassis and means for controlling the translational movement of the third axis of each assembly along a beam segment, each module being able to adopt a position in which a half-frame extends in a horizontal plane above a rolling base and a position in which a half-frame extends in a vertical plane above a rolling base by pivoting of the first arm around the second axis.

10. The medical bed, according to claim 9, further comprising: means for securing the two modules to one another when they are placed in the position in which a half-plane extends in a vertical plane above a rolling base.
